(19) United States
(12) Patent Application Publication
(10) Pub. No.: US 2024/0097175 A1
(43) Pub. Date: Mar. 21, 2024

(54) BATTERIES AND METHODS OF MAKING THE SAME

(71) Applicant: CORNING INCORPORATED, Corning, NY (US)

(72) Inventors: Michael Edward Badding, Campbell, NY (US); Zhen Song, Painted Post, NY (US); Jianmeng Su, Shanghai (CN); Tongping Xiu, Shanghai (CN)

(21) Appl. No.: 18/368,154

(22) Filed: Sep. 14, 2023

(30) Foreign Application Priority Data
Sep. 19, 2022 (CN) 202211136995.5

(51) Int. Cl. H01M 10/04; H01M 4/04; H01M 4/134; H01M 4/1395; H01M 4/38; H01M 10/0562

(52) U.S. Cl. CPC H01M 10/0427; H01M 4/0407; H01M 4/134; H01M 4/1395; H01M 4/382; H01M 10/0562; H01M 2004/027

(57) ABSTRACT

Batteries include a cathode, a solid-state electrolyte, and an anode. In aspects, the anode comprises an alloy including from about 50 atom % to about 90 atom % lithium, from about 5 atom % to about 50 atom % of a first component, and from about 0.1 atom % to about 10 atom % of a second component. In aspects, the anode includes from about 20 atom % to about 99 atom % of a first component and from about 1 atom % to about 20 atom % of a second component. The first component is selected from a group consisting of magnesium, silver, and combinations thereof. The second component is selected from a group consisting of calcium, aluminum, gallium, boron, carbon, silicon, tin, zinc, indium, antimony, silver, and combinations thereof. An amount of the first component is greater than an amount of the second component. The solid-state electrolyte is positioned between the cathode and the anode.

### CROSS-REFERENCE TO RELATED APPLICATIONS

This application claims the benefit of priority under 35 U.S.C. § 119 of Chinese Patent Application Serial No. 202211136995.5 filed on Sep. 19, 2022 the content of which is relied upon and incorporated herein by reference in its entirety.

### FIELD

The present disclosure relates to batteries and methods of manufacturing thereof, and more particularly batteries comprising a solid-state electrolyte and an anode comprising an alloy and methods of making the same.

### BACKGROUND

Solid-state batteries (SSBs) (e.g., SS lithium (Li) metal batteries based on inorganic solid-state electrolytes (SSEs) (such as garnet-type SSE)) have attracted much attention due to their high safety, improved energy density, high ionic conductivity, and stability against Li metal. However, conventional Li-metal batteries often suffer from issues with capacity retention and/or longevity, especially when operated at higher capacities.

Consequently, there is a need to address these issues.

### SUMMARY

The present disclosure provides batteries and methods of making the same comprising an alloy anode. The alloy anode comprises at least a first component and a second component. The first component can for a solid solution with a metal and/or metal ion (e.g., Li/Li+) that is transported during cycling of the battery. The second component may not form a solid solution with the first component, metal and/or the material (e.g., Li/Li+) transported during cycling of the battery. Providing the first component and the second component (with an amount of the first component greater than an amount of the second component) can enable the anode to remain in contact with the solid-state electrolyte even when the battery is in a discharged state and/or the battery is subjected to charging/discharging-induced stresses, for example, because the first component and the second component may not be transferred during cycling (e.g., charging, discharging). Maintaining contact between the anode and the solid-state electrolyte during cycling can minimize interfacial resistance therebetween, which can increase a capacity retention and longevity of the battery. As demonstrated in the Examples, including the second component can unexpectedly improve performance (e.g., capacity retention, longevity) of batteries compared to lithium metal anodes and binary alloy anodes as well as when analyzing the microstructure of such anodes (see SEM images). Maintaining a high capacity retention (e.g., 95% or more after 50 cycles or more to a nominal capacity of 2.1 mAh/cm², 93% or more after 50 cycles or more to a nominal capacity of 3.3 mAh/cm², 95% or more after 50 cycles or more to a nominal capacity of 3.5 mAh/cm², 95% or more after 20 cycles to a nominal capacity of 5 mAh/cm²) can enable the solid-state battery to be functional for an intended use for a longer period of time than would otherwise be possible.

Providing a majority of the atoms in the alloy (e.g., in a battery in a fully charged state) as lithium allows for the anode to be used in high area capacity (e.g., 2.1 mAh/cm² or more, 3.3 mAh/cm² or more, 5 mAh/cm² or more). In aspects, providing an as-formed anode with reduced lithium, substantially free of lithium, and/or free of lithium can simplify processing and/or reduce manufacturing costs while still achieving a functional battery, where an amount of lithium in the anode increases during charging as lithium in other components (e.g., cathode, solid-state electrolyte) is transported to the anode.

Providing a solid-state electrolyte (e.g., in a solid-state battery) can address common safety concerns, for example, leakage, poor chemical stability, and flammability often seen in batteries employing liquid electrolytes. Moreover, providing a solid-state electrolyte can also suppress polysulfide shuttling from the cathode to the anode, thereby leading to improved electrode (e.g., anode, cathode) utilization and a high discharge capacity and energy density. Providing a solid-state electrolyte can reduce a formation of dendrites (e.g., lithium dendrites) that can otherwise result in failure of the battery. Providing an interlayer 114 comprising a liquid electrolyte can wet the interface between the cathode 104 and the solid-state electrolyte to reduce interfacial resistance therebetween while minimizing a total amount of liquid electrolyte in the solid-state battery 101.

Some example aspects of the disclosure are described below with the understanding that any of the features of the various aspects may be used alone or in combination with one another.
Aspect 1. A battery comprising:
a cathode;
a solid-state electrolyte; and
an anode comprising an alloy comprising, as an atom % of the alloy as-formed or in a fully charged state:
   from about 50 atom % to about 90 atom % of lithium;
   from about 5 atom % to about 50 atom % of a first component selected from a group consisting of magnesium, silver, and combinations thereof, and
   from about 0.1 atom % to about 10 atom % of a second component selected from a group consisting of calcium, aluminum, gallium, boron, carbon, silicon, tin, zinc, indium, antimony, silver, and combinations thereof,
wherein the solid-state electrolyte is positioned between the cathode and the anode, and an amount of the first component is greater than an amount of the second component.
Aspect 2. The battery of aspect 1, wherein a thickness of the anode is from 1 micrometer to about 500 micrometers.
Aspect 3. The battery of any one of aspects 1-2, wherein the first component is from about 8 atom % to about 15 atom %.
Aspect 4. The battery of any one of aspects 1-3, wherein the second component is from about 0.1 atom % to about 3 atom %.
Aspect 5. The battery of any one of aspects 1-4, wherein the solid-state electrolyte comprises a lithium-phosphorous-oxynitride (LiPON), lithium garnet (Li₇La₃Zr₂O₁₂), lithium phosphosulfide, or combinations thereof.
Aspect 6. The battery of any one of aspects 1-5, wherein a capacity of the battery after 50 cycles is from about 95% to 100% of an initial capacity, each cycle comprises a charging current density of 2 mA/cm² to a nominal capacity of 2.1 mAh/cm² and a discharge current density of 0.75 mAh/cm² while the battery is maintained at 60° C.
Aspect 7. The battery of any one of aspects 1-5, wherein a capacity of the battery after 50 cycles is from about 93% to 100% of an initial capacity, each cycle comprises a charging current density of 2 mA/cm² to a nominal capacity of 3.3 mAh/cm² and a discharge current density of 0.75 mAh/cm² while the battery is maintained at 60° C.
Aspect 8. The battery of any one of aspects 1-7, wherein the alloy of the anode comprises, as an atom % of the alloy as-formed, comprises:
from about 20 atom % to about 99 atom % of the first component; and from about 1 atom % to about 20 atom % of a second component
Aspect 9. A battery comprising:
a cathode;
a solid-state electrolyte; and
an anode comprising an alloy comprising, as an atom % of the alloy as-formed:
   from about 20 atom % to about 99 atom % of a first component selected from a group consisting of magnesium, silver, and combinations thereof, and
   from about 1 atom % to about 20 atom % of a second component selected from a group consisting of calcium, aluminum, gallium, boron, carbon, silicon, tin, zinc, indium, antimony, and combinations thereof,
wherein the solid-state electrolyte is positioned between the cathode and the anode, and an amount of the first component is greater than an amount of the second component.
Aspect 10. The battery of aspect 8 or aspect 9, wherein one or both of the cathode or the solid-state electrolyte comprises lithium, and the anode consists of from about 80 atom % to about 99 atom % of the first component and from about 1 atom % to about 20 atom % of the second component.
Aspect 11. The battery of any one of aspects 9-10, wherein a thickness of the anode is from 1 micrometer to about 500 micrometers.
Aspect 12. The battery of any one of aspects 9-11, wherein the solid-state electrolyte comprises a lithium-phosphorous-oxynitride (LiPON), lithium garnet (Li₇La₃Zr₂O₁₂), lithium phosphosulfide, or combinations thereof.
Aspect 13. The battery of any one of aspects 9-12, wherein a capacity of the battery after 50 cycles is from about 95% to 100% of an initial capacity, each cycle comprises a charging current density of 2 mA/cm² to a nominal capacity of 2.1 mAh/cm² and a discharge current density of 0.75 mAh/cm² while the battery is maintained at 60° C.
Aspect 14. The battery of any one of aspects 9-12, wherein a capacity of the battery after 50 cycles is from about 93% to 100% of an initial capacity, each cycle comprises a charging current density of 2 mA/cm² to a nominal capacity of 3.3 mAh/cm² and a discharge current density of 0.75 mAh/cm² while the battery is maintained at 60° C.
Aspect 15. The battery of any one of aspects 9-13, wherein after at least one cycle, the anode comprises, as an atom % of the alloy in a fully charged state:
from about 50 atom % to about 90 atom % of lithium;
from about 5 atom % to about 50 atom % of the first component; and
from about 0.1 atom % to about 10 atom % of the second component.
Aspect 16. A method of making the battery of aspect 1, comprising:
disposing the anode on the solid-state electrolyte by disposing the alloy on the solid-state electrolyte; and
disposing the solid-state electrolyte on the cathode, wherein the solid-state electrolyte is positioned between the cathode and the anode.
Aspect 17. A method of making a battery comprising:
disposing an anode on a solid-state electrolyte by disposing an alloy on the solid-state electrolyte; and
disposing the solid-state electrolyte on the cathode, wherein the solid-state electrolyte is positioned between the cathode and the anode,
wherein the anode comprising an alloy comprising, as an atom % of the alloy as-formed or in a fully charged state:
   from about 50 atom % to about 90 atom % of lithium;
   from about 5 atom % to about 50 atom % of a first component selected from a group consisting of magnesium, silver, and combinations thereof, and
   from about 0.1 atom % to about 10 atom % of a second component selected from a group consisting of calcium, aluminum, gallium, boron, carbon, silicon, tin, zinc, indium, antimony, silver, and combinations thereof.
Aspect 18. The method of any one of aspects 16-17, wherein the disposing the alloy comprises depositing one or more materials in a molten state on the solid-state electrolyte in an environment maintained at a temperature greater than a melting point of the one or more materials by about 100° C. or more for from about 5 minutes to about 30 minutes.
Aspect 19. The method of any one of aspects 16-17, wherein disposing the alloy comprising sputtering or thermal evaporation to dispose the anode.
Aspect 20. The method of any one of aspects 16-19, wherein a thickness of the anode is from 1 micrometer to about 500 micrometers.
Aspect 21. The method of any one of aspects 16-20, wherein a thickness of the anode, as-formed or in a fully charged state, is from 1 micrometer to about 500 micrometers.
Aspect 22. The method of any one of aspects 16-21, wherein the first component is from about 8 atom % to about 15 atom %.
Aspect 23. The method of any one of aspects 16-22, wherein the second component is from about 0.1 atom % to about 3 atom %.
Aspect 24. The method of any one of aspects 16-23, wherein the solid-state electrolyte comprises a lithium-phosphorous-oxynitride (LiPON), lithium garnet (Li₇La₃Zr₂O₁₂), lithium phosphosulfide, or combinations thereof.
Aspect 25. The method of any one of aspects 16-24, wherein a capacity of the battery after 50 cycles is from about 95% to 100% of an initial capacity, each cycle comprises a charging current density of 2 mA/cm² to a nominal capacity of 2.1 mAh/cm² and a discharge current density of 0.75 mAh/cm² while the battery is maintained at 60° C.
Aspect 26. The method of any one of aspects 16-24, wherein a capacity of the battery after 50 cycles is from about 93% to 100% of an initial capacity, each cycle comprises a charging current density of 2 mA/cm² to a nominal capacity of 3.3 mAh/cm² and a discharge current density of 0.75 mAh/cm² while the battery is maintained at 60° C.
Aspect 27. A method of making the battery of aspect 9, comprising:
disposing the anode on the solid-state electrolyte by disposing the alloy on the solid-state electrolyte; and
disposing the solid-state electrolyte on the cathode, wherein the solid-state electrolyte is positioned between the cathode and the anode.
Aspect 28. A method of making a battery, comprising:
disposing an anode on a solid-state electrolyte by disposing an alloy on the solid-state electrolyte; and
disposing the solid-state electrolyte on the cathode, wherein the solid-state electrolyte is positioned between the cathode and the anode,
wherein the anode comprising an alloy comprising, as an atom % of the alloy as-formed:
   from about 20 atom % to about 99 atom % of a first component selected from a group consisting of magnesium, silver, and combinations thereof, and
   from about 1 atom % to about 20 atom % of a second component selected from a group consisting of calcium, aluminum, gallium, boron, carbon, silicon, tin, zinc, indium, antimony, silver, and combinations thereof.
Aspect 29. The method of any one of aspects 27-28, wherein disposing the alloy comprising sputtering or thermal evaporation to dispose the anode.
Aspect 30. The method of any one of aspects 27-29, wherein a thickness of the anode is from 1 micrometer to about 500 micrometers.
Aspect 31. The method of any one of aspects 24-30, wherein the solid-state electrolyte comprises a lithium-phosphorous-oxynitride (LiPON), lithium garnet (Li₇La₃Zr₂O₁₂), lithium phosphosulfide, or combinations thereof.
Aspect 32. The method of any one of aspects 27-31, wherein a capacity of the battery after 50 cycles is from about 95% to 100% of an initial capacity, each cycle comprises a charging current density of 2 mA/cm² to a nominal capacity of 2.1 mAh/cm² and a discharge current density of 0.75 mAh/cm² while the battery is maintained at 60° C.
Aspect 33. The method of any one of aspects 27-31, wherein a capacity of the battery after 50 cycles is from about 93% to 100% of an initial capacity, each cycle comprises a charging current density of 2 mA/cm² to a nominal capacity of 3.3 mAh/cm² and a discharge current density of 0.75 mAh/cm² while the battery is maintained at 60° C.
Aspect 34. The method of any one of aspects 27-31, further comprising, after disposing the anode, cycling the battery at least one time, wherein after the cycling the battery at least one time, the anode, as an atom % of the alloy in a fully charged state, comprises:
from about 50 atom % to about 90 atom % of lithium;
from about 5 atom % to about 50 atom % of the first component; and
from about 0.1 atom % to about 10 atom % of the second component.
Aspect 35. The method of aspect 34, wherein, in the fully charged state, the first component is from about 8 atom % to about 15 atom %.
Aspect 36. The method of any one of aspects 34-35, wherein, in the fully charged state, the second component is from about 0.1 atom % to about 3 atom %.

### BRIEF DESCRIPTION OF THE DRAWINGS

The above and other features and advantages of aspects of the present disclosure are better understood when the following detailed description is read with reference to the accompanying drawings, in which:

FIG. 1 schematically illustrates a general structure of a solid-state battery in accordance with aspects of the disclosure;

FIG. 2 illustrates a simplified solid-state battery with an anode in accordance with aspects of the disclosure;

FIG. 3 illustrates a step in an exemplary method comprising disposing an alloy on a solid-state electrolyte;

FIG. 4 illustrates a step in an exemplary method comprising disposing an alloy on a solid-state electrolyte;

FIG. 5 illustrates a step in an exemplary method comprising heating the alloy and solid-state electrolyte;

FIG. 6 illustrates a step in an exemplary method comprising disposing a cathode on the solid-state electrolyte opposite the alloy;

FIG. 7 illustrates a Nyquist plots for Comparative Examples 1, 3, and 5;

FIG. 8 illustrates capacity retention for Comparative Examples 1, 3, and 5;

FIG. 9 illustrates capacity retention for Examples 3 and Comparative Examples 2 and 4;

FIG. 10 illustrates capacity retention for Examples 1-2;

FIG. 11 illustrates capacity-voltage (CV) curves for Example 4;

FIG. 12 illustrates capacity-voltage (CV) curves for Example 5;

FIG. 13 schematically illustrates an SEM image of a surface of the anode of Comparative Example 1;

FIG. 14 schematically illustrates an SEM image of a surface of the anode of Comparative Example 3;

FIG. 15 illustrates changes in interfacial resistance for Comparative Example 3;

FIG. 16 illustrates changes in interfacial resistance for Example 1;

FIG. 17 illustrates changes in interfacial resistance for Example 2;

FIG. 18 illustrates changes in interfacial resistance for Example 4; and

FIG. 19 illustrates changes in interfacial resistance for Example 5.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

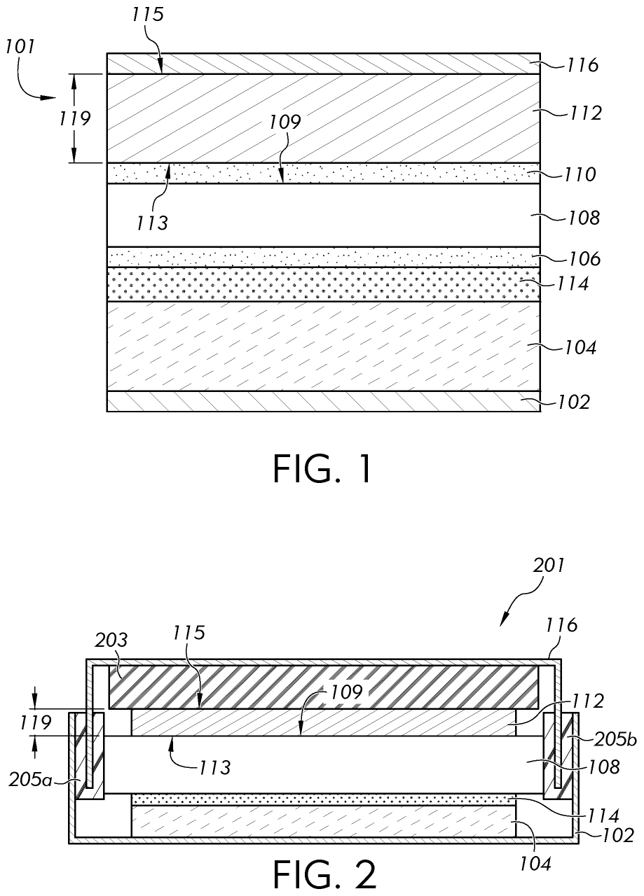

FIGS. 1-2 illustrate views of a solid-state battery 101 or 201 comprising an anode 112 comprising an alloy in accordance with aspects of the disclosure. In aspects, the alloy can be disposed as a binary alloy, a ternary alloy, or higher-order alloy. In aspects, after at least one charging cycle and in the fully charged state, the alloy can comprise a ternary alloy or a higher-order alloy. Unless otherwise noted, a discussion of features of aspects of one foldable apparatus can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

FIG. 1 schematically illustrates a general structure of a solid-state battery 101, and FIG. 2 illustrates a simplified solid-state battery 201 in a coin-cell form. As shown in FIG. 1, the solid-state battery 101 or 201 can include, sequentially, a first current collector 102 (e.g., substrate), a cathode 104 disposed on the first current collector 102, an optional interlayer 114 disposed on the cathode 104, an optional first coating 106, a solid-state electrolyte 108, an optional second interlayer and/or second coating 110, an anode 112, and a second current collector 116 disposed on the anode 112. As shown in FIG. 1, the solid-state battery 101 can optionally comprise a first coating 106 disposed on the cathode 104. As shown in FIGS. 1-2, the solid-state electrolyte 108 is positioned between the cathode 104 and the anode 112. The components of the solid-state battery 101 can be disposed horizontally in relation to each other or vertically.

The first current collector 102 comprises an electrically conductive material. As used herein, electrically conductive materials have an electronic conductivity of 100 Siemens per meter (S/m) measured at 20° C. in accordance with ASTME1004-17. In aspects, the first current collector can comprise nickel (Ni) foam, carbon fiber, or a solid metal contact (e.g., aluminum, stainless steel, copper, platinum, nickel, gold, zinc, cobalt, nickel, ruthenium, lithium, lead, titanium, nichrome, etc.). In aspects, the first current collector 102 can be a mechanically stable and/or dimensionally stable substrate that supports the other elements of the solid-state battery 101 or 201. In aspects, the first current collector 102 can comprise the same material as the cathode 104 (discussed below) such that the first current collector 102 is part of the cathode 104.

The cathode 104 comprises an electrically conductive material. In aspects, the cathode 104 can be configured to release and reincorporate a cation (e.g., alkali metal—lithium or sodium, alkali earth metal—magnesium or calcium). In aspects, the cathode 104 can comprise at least one of an alkali metal (e.g., lithium, sodium) or an alkaline earth metal (e.g., magnesium, calcium). In aspects, the cathode 104 can comprise one or more of the materials discussed below for the anode 112. In further aspects, the cathode 104 can comprise the same material as the anode 112. In aspects, the cathode 104 can comprise a fluoride compound. In further aspects, the cathode 104 can comprise at least one transition metal, for example, cobalt, manganese, nickel, niobium, tantalum, vanadium, titanium, copper, chromium, tungsten, molybdenum, tin, germanium, antimony, bismuth, iron, or combinations thereof. In aspects, the cathode 104 can comprise a lithium-based electrode, for example lithium cobaltite (LCO), lithium manganite spinel (LMO), lithium nickel cobalt aluminate (NCA), lithium nickel manganese cobalt oxide (NCM) (LiNi_{d}CoₑMn_{1-d-e}O₂, where 0<d<1, 0<e<1, for example, LiNi_{0.5}Co_{0.2}Mn_{0.3}O₂ (NCM523), LiNi_{0.6}Co_{0.2}Mn_{0.2}O₂ (NCM622), etc.), lithium iron phosphate (LiFePO₄) (LFP), lithium cobalt phosphate (LCP), lithium titanate, lithium niobium tungstate, lithium nickel manganate, lithium titanium sulfide (LiTiS₂), or combinations thereof. In aspects, the cathode 104 can comprise a sodium-based electrode, for example, NaVPO₄F, NaMnO₂, Na_{2/3}Mn_{1-y}Mg_{y}O₂ (0<y<1), Na₂Li₂Ti₅O₁₂, Na₂Ti₃O₇, or combinations thereof. In aspects, the cathode 104 can comprise a magnesium-based electrode, for example, magnesiochromite (MgCr₂O₄), MgMn₂O₄, or combinations thereof. The cathode 104 can be a sintered electrode. Alternatively, the cathode 104 can be unsintered. An exemplary aspect of a cathode 104 is a NCM cathode.

As shown in FIG. 1, the solid-state battery 101 can optionally comprises an interlayer 114 positioned between the cathode 104 and the solid-state electrolyte 108. In aspects, the interlayer 114 can comprise a liquid electrolyte (e.g., ionic liquid, deep eutectic solvent (DES), or an aprotic solvent). As used herein, an “electrolyte” enables the transport of ions therein (“ion conductivity”), and the ion conductivity corresponds to an electrical conductivity of the electrolyte (e.g., DES-based electrolyte). The interlayer 114 can a liquid at room temperature (i.e., 25° C.) and/or at an operating temperature of the solid-state battery 101 (e.g., from about 50° C. to about 60° C.). Providing an interlayer 114 comprising a liquid electrolyte can wet the interface between the cathode 104 and the solid-state electrolyte to reduce interfacial resistance therebetween while minimizing a total amount of liquid electrolyte in the solid-state battery 101.

As shown in FIGS. 1-2, the solid-state battery 101 and 201 comprises the solid-state electrolyte 108 positioned between the cathode 104 and the anode 112. Throughout the disclosure, “solid-state batteries” comprise a solid-state electrolyte. As used herein, a solid-state electrolyte is a material that is solid at room temperature and at an operating temperature (e.g., about 50° C.) of the solid-state battery. In aspects, the solid-state electrolyte 108 can comprise an inorganic solid-state electrolyte. Providing a solid-state electrolyte can address common safety concerns, for example, leakage, poor chemical stability, and flammability often seen in batteries employing liquid electrolytes. Moreover, providing a solid-state electrolyte can also suppress polysulfide shuttling from the cathode to the anode, thereby leading to improved electrode (e.g., anode, cathode) utilization and a high discharge capacity and energy density. Providing a solid-state electrolyte can reduce a formation of dendrites (e.g., lithium dendrites) that can otherwise result in failure of the battery.

In aspects, the solid-state electrolyte 108 can comprise a lithium-phosphorous-oxynitride (LiPON), lithium garnet (Li₇La₃Zr₂O₁₂), lithium phosphosulfide, or combinations thereof. In further aspects a UPON material can comprise the structure Li_{3+y}PO₄₋ₓNₓ, where y>0 and 0<x<4. In further aspects, the solid-state electrolyte 108 can comprise lithium, lanthanum, zirconium, oxygen, or combinations thereof (e.g., each of lithium, lanthanum, zirconium, and oxygen—a LLZO compound). As used herein, “LLZO” refers to compounds including lithium, lanthanum, zirconium, and oxygen. In even further aspects, the solid-state electrolyte 108 can comprise a lithium-garnet, for example, at least one of: (i) Li₇₋₃ₐLa₃Zr₂LaO₁₂, with L=Al, Ga or Fe and 0<a<0.33; (ii) Li₇La_{3-b}Zr₂MbO₁₂, with M=Bi or Y and 0<b<1; (iii) Li_{7-c}La₃(Zr_{2-c},N_{c})O₁₂, with N═In, Si, Ge, Sn, V, W, Te, Nb, or Ta and 0<c<1; (iv) protonated LLZO (e.g., HₓLi_{6.25-x}La₃Zr_{1.5}I_{0.5}O₁₂, with I═In, Si, Ge, Sn, V, W, Te, Nb, or Ta and 0<x<4 or HₓLi_{6.25-x}E_{0.25}La₃Zr₂O₁₂, with E=Al, Ga or Fe and 0<x<4), or a combination thereof. In aspects, the solid-state electrolyte 108 can comprise at least one of Li₁₀GeP₂S₁₂, Li_{1.5}Al_{0.5}Ge_{1.5}(PO₄)₃, Li_{1.4}Al_{0.4}T_{1.6}(PO₄)₃, Li_{0.55}La_{0.35}TiO₃, interpenetrating polymer networks of poly(ethyl acrylate) (ipn-PEA) electrolyte, three-dimensional ceramic/polymer networks, in-situ plasticized polymers, composite polymers with well-aligned ceramic nanowires, PEO-based solid-state polymers, flexible polymers, polymeric ionic liquids, in-situ formed Li₃PS₄, Li₆PS₅Cl, or combinations thereof.

In aspects, the optional first coating 106 can comprise a carbon-based interlayer (e.g., interlinked freestanding, micro/mesopore containing, functionalized, biomass-derived), a polymer-based interlayer, a metal-based coating (e.g., Ni foam, etc.), a liquid electrolyte (e.g., LiPF₆ in ethylene carbonate (EC)/dimethyl carbonate (DMC)), ionic liquid-based (e.g., LiCF₃SO₃/CH₃CONH₂, LiTFSI/N-methylacetamide (NMA), PEG₁₈LiTFSI-10% SiO₂-10% IL, etc., where LiTFSI is bis(trifluoromethane) sulfonimide lithium salt (LiN(CF₃SO₂)₂), SiO₂ may be nanoparticles, and IL is an ionic liquid), or a combination thereof. Exemplary aspects of polymer-based interlayers include carbon polysulfides (CS), polyethylene oxides (PEO), polyaniline (PANI), polypyrrole (PPY), poly(3,4-ethylenedioxythiophene) (PEDOT), poly(styrene sulfonic acid) (PSS), polyacrylonitrile (PAN), polyacrylic acid (PAA), polyallylamine hydrochloride (PAH), poly(vinylidene fluoride-co-hexafluoropropylene) (P(VDF-co-HFP)), poly(methyl methacrylate) (PMMA), polyvinylidene fluoride (PVDF), poly(diallyldimethyl ammonium) bis(trifluoromethanesulfonyl)imide (TFSI) (PDDATFSI), or combinations thereof. In aspects, the first coating 106 can comprise at least one of, or at least two of, or at least three elements selected from a group consisting of nitrogen, carbon, cobalt, titanium, tantalum, and tungsten.

In aspects, the optional second interlayer or second coating 110 can comprise the materials or aspects discussed above the first coating 106 and/or the interlayer 114. In aspects, the optional second interlayer or second coating 110 can comprise an anode protector, for example, electrolyte additives (e.g., LiNO₃, lanthanum nitrate, copper acetate, P₂S₅, etc.), artificial interfacial layers (e.g., Li₃N, (CH₃)₃SiCl, Al₂O₃, LiAl, etc.), composite metallics (e.g., Li₇B₆, Li-rGO (reduced graphene oxide), layered Li-rGO, etc.), or combinations thereof. In aspects, the optional second interlayer or second coating 110 can comprise a thin layer of metal (e.g., Au) that may be ion-sputter coated to form a contact interface between the anode 112 the solid-state electrolyte 108 and another material of the optional second interlayer or second coating 110 or and another material of the optional second interlayer or second coating 110. In aspects, as shown in FIG. 2, the solid-state battery 201 may not have the optional second interlayer or second coating such that the anode 112 contacts the solid-state electrolyte 108.

As shown in FIGS. 1-2, the anode 112 can be disposed on the solid-state electrolyte 108. In aspects, as shown in FIG. 2, a first major surface 113 of the anode 112 can be disposed on and/or contact a first major surface 109 of the solid-state electrolyte 108. As shown, the anode 112 comprises a second major surface 115 opposite the first major surface 113 with an anode thickness 119 defined as an average distance therebetween when the solid-state battery 201 is in a fully charged state (defined below). In aspects, the anode thickness 119 can be about 1 micrometer (μm) or more, about 10 μm or more, about 50 μm or more, about 100 μm or more, about 150 μm or more, about 500 μm or less, about 400 μm or less, about 300 μm or less, or about 250 μm or less. In aspects, the anode thickness 119 can range from about 1 μm to about 500 μm, from about 10 μm to about 400 μm, from about 50 μm to about 300 μm, from about 100 μm to about 300 μm, from about 150 μm to about 250 μm, or any range or subrange therebetween.

The anode 112 comprises an alloy of at least two components: a first component and a second component. In aspects, the anode 112 can consist of the alloy. In aspects, the first component can form a solid-solution with lithium and/or be miscible with lithium. In aspects, the first component can be selected from a group consisting of magnesium (Mg), silver (Ag), and combinations thereof. In aspects, an amount of the first component can be greater than an amount of the second component in the alloy, in atom %. A material of the second component is different than a material of the first component (i.e., the first component cannot comprise silver with the second component simultaneously comprising silver, but otherwise either component can comprise silver). In aspects, the second component can be selected from a group consisting of calcium (Ca), aluminum (Al), gallium (Ga), boron (B), carbon (C), silicon (Si), tin (Sn), zinc (Zn), indium (In), antimony (Sb), silver (Ag), and combinations thereof. Exemplary aspects of the second component include calcium (Ca), tin (Sn), and silver (Ag).

In aspects, the alloy of the anode 112 can comprise lithium in an as-formed state. The alloy of the anode 112 can comprise lithium when the solid-state battery 101 or 201 is in a fully charged state (defined below). In aspects, the alloy of the anode 112 (as-formed and/or when the solid-state battery is in a fully charged state), can comprise lithium in an amount of about 50 atom % or more, about 51 atom % or more, about 55 atom % or more, about 60 atom % or more, about 65 atom % or more, about 70 atom % or more, about 75 atom % or more, about 90 atom % or less, about 89 atom % or less, about 88 atom % or less, about 87 atom % or less, about 86 atom % or less, about 85 atom % or less, about 82 atom % or less, about 80 atom % or less, about 75 atom % or less, about 70 atom % or less, or about 65 atom % or less. In aspects, the alloy of the anode 112 (as-formed and/or when the solid-state battery is in a fully charged state), can comprise lithium in a range from about 50 atom % to about 90 atom %, from about 51 atom % to about 89 atom %, from about 55 atom % to about 88 atom %, from about 60 atom % to about 87 atom %, from about 65 atom % to about 86 atom %, from about 70 atom % to about 85 atom %, from about 70 atom % to about 82 atom %, from about 75 atom % to about 80 atom %, or any range or subrange therebetween. In aspects, the alloy of the anode 112 (as-formed and/or when the solid-state battery is in a fully charged state) can comprise the first component in an amount of about 5 atom % or more, about 6 atom % or more, about 7 atom % or more, about 8 atom % or more, about 9 atom % or more, about 10 atom % or more, about 20 atom % or more, about 50 atom % or less, about 40 atom % or less, about 30 atom % or less, about 20 atom % or less, about 15 atom % or less, about 13 atom % or less, or about 11 atom % or less. In aspects, the alloy of the anode 112 (as-formed and/or when the solid-state battery is in a fully charged state) can comprise the first component in an amount ranging from about 5 atom % to about 50 atom %, from about 5 atom % to about 40 atom %, from about 6 atom % to about 30 atom %, from about 7 atom % to about 20 atom %, from about 8 atom % to about 15 atom %, from about 9 atom % to about 13 atom %, from about 10 atom % to about 11 atom %, or any range or subrange therebetween. In aspects, the alloy of the anode 112 (as-formed and/or when the solid-state battery is in a fully charged state) can comprise the second component in an amount of about 0.1 atom % or more, about 0.2 atom % or more, about 0.3 atom % or more, about 0.4 atom % or more, about 0.5 atom % or more, about 1 atom % or more, about 3 atom % or more, about 5 atom % or more, about 10 atom % or less, about 7 atom % or less, about 5 atom % or less, about 4 atom % or less, about 3 atom % or less, about 2 atom % or less, about 1 atom % or less, about 0.8 atom % or less, about 0.4 atom % or less, or about 0.3 atom % or less. In aspects, the alloy of the anode 112 (as-formed and/or when the solid-state battery is in a fully charged state) can comprise the second component in a range from about 0.1 atom % to about 10 atom %, from about 0.1 atom % to about 8 atom %, from about 0.2 atom % to about 5 atom %, from about 0.2 atom % to about 4 atom %, from about 0.3 atom % to about 3 atom %, from about 0.3 atom % to about 2 atom %, from about 0.4 atom % to about 1 atom %, or any range or subrange therebetween. In aspects, the alloy of the anode 112 (as-formed and/or when the solid-state battery is in a fully charged state) can comprise the second component in an amount of less than 3 atom %, for example, in a range from about 0.1 atom % to about 3 atom %, from about 0.1 atom % to about 2 atom %, from about 0.1 atom % to about 0.8 atom %, from about 0.1 atom % to about 0.4 atom %, from about 0.2 atom % to about 0.4 atom %, from about 0.2 atom % to about 0.3 atom %, or any range or subrange therebetween. Providing a majority of the atoms in the alloy (e.g., in a battery in a fully charged state) as lithium allows for the anode to be used in high area capacity (e.g., 2.1 mAh/cm² or more, 3.3 mAh/cm² or more, 5 mAh/cm² or more) and/or a high charging current density (e.g., about 2 mA/cm² or more). Providing the first component and the second component within one of the corresponding above-mentioned ranges can enable the anode to remain in contact with the solid-state electrolyte even when the battery is in a discharged state and/or the battery is subjected to charging/discharging-induced stresses, for example, because the first component and the second component may not be transferred during cycling (e.g., charging, discharging). Maintaining contact between the anode and the solid-state electrolyte during cycling can minimize interfacial resistance therebetween, which can increase a capacity retention and longevity of the battery.

Table 1 presents exemplary ranges R1-R5 for the alloy of the anode 112 as-formed and/or when the battery is in a fully charged state in accordance with the aspects discussed in the previous paragraph. Range R1 corresponds to the broadest range, and Ranges R2-R5 are subranges therein. Going from R1 to R3, the range of each component (e.g., lithium, first component, second component) decreases, corresponding to more preferred ranges. Compared to Ranges R2-R3, Ranges R4-R5 correspond to greater amounts of the first component.

TABLE 1
Composition (atom %) of the Alloy of the Anode
(as-formed or in a fully charged state)

| Range | R1 | R2 | R3 | R4 | R5 |
|---|---|---|---|---|---|
| Lithium | 50-99 | 75-95 | 85-92 | 50-80 | 50-80 |
| First Component | 5-50 | 5-20 | 8-15 | 20-50 | 20-50 |
| Second Component | 0.1-5 | 0.1-3 | 0.1-0.4 | 0.1-5 | 0.1-0.4 |

Alternatively or additionally, the alloy of the anode 112 as-formed can comprise the first component in an amount of about 20 atom % or more, about 30 atom % or more, about 35 atom % or more, about 38 atom % or more, about 40 atom % or more, about 50 atom % or more, about 60 atom % or more, about 70 atom % or more, about 80 atom % or more, about 85 atom % or more, about 88 atom % or more, about 90 atom % or more, about 99 atom % or less, about 98 atom % or less, about 97 atom % or less, about 96 atom % or less, about 95 atom % or less, about 93 atom % or less, about 90 atom % or less, about 85 atom % or less, about 80 atom % or less, about 70 atom % or less, or about 50 atom % or less. In aspects, the alloy of the anode 112 as-formed can comprise the first component in a range from about 20 atom % to about 99 atom %, from about 30 atom % to about 98 atom %, from about 40 atom % to about 97 atom %, from about 50 atom % to about 96 atom %, from about 60 atom % to about 95 atom %, from about 70 atom % to about 93 atom %, from about 80 atom % to about 90 atom %, from about 85 atom % to about 90 atom %, from about 88 atom % to about 90 atom %, or any range or subrange therebetween. In aspects, the alloy of the anode 112 as-formed can comprise the second component in an amount of about 1 atom % or more, about 2 atom % or more, about 3 atom % or more, about 5 atom % or more, about 7 atom % or more, about 9 atom % or more, about 11 atom % or more, about 20 atom % or less, about 18 atom % or less, about 16 atom % or less, about 14 atom % or less, about 12 atom % or less, or about 10 atom % or less. In aspects, the alloy of the anode 112 as-formed can comprise the second component in a range from about 1 atom % to about 20 atom %, from about 2 atom % to about 18 atom %, from about 3 atom % to about 16 atom %, from about 4 atom % to about 14 atom %, from about 5 atom % to about 12 atom %, from about 7 atom % to about 12 atom %, from about 9 atom % to about 12 atom %, from about 9 atom % to about 10 atom %, or any range or subrange therebetween. In aspects, the alloy of the anode 112 as-formed can be substantially free (i.e., 5 atom % or less) of lithium or free of lithium, for example, with lithium being provided to the alloy of the anode 112 during charging of the solid-state battery from other components of the solid-state battery. Alternatively, in aspects, the alloy of the anode 112 as-formed can comprise lithium, for example, from about 10 wt % to about 50 wt %, from about 15 wt % to about 40 wt %, from about 20 wt % to about 30 wt %, or any range or subrange therebetween, for example, with additional lithium being provided to the alloy of the anode 112 during charging of the solid-state battery from other components of the solid-state battery. Providing an as-formed anode with reduced lithium, substantially free of lithium, and/or free of lithium can simplify processing and/or reduce manufacturing costs while still achieving a functional battery, where an amount of lithium in the anode increases during charging as lithium in other components (e.g., cathode, solid-state electrolyte) is transported to the anode, which can produce an alloy composition within one or more of the ranges discussed above (e.g., see Ranges R1-R5). Providing the first component and the second component within one of the corresponding above-mentioned ranges can enable the cathode to remain in contact with the solid-state electrolyte even when the battery is in a discharged state and/or the battery is subjected to charging/discharging-induced stresses, for example, because the first component and the second component may not be transferred during cycling (e.g., charging, discharging). Maintaining contact between the cathode and the solid-state electrolyte during cycling can minimize interfacial resistance therebetween, which can increase a capacity retention and longevity of the battery.

Table 1 presents exemplary ranges R6-R11 for the alloy of the anode 112 as-formed in accordance with the aspects discussed in the previous paragraph. Range R6 corresponds to the broadest range, and Ranges R6-R11 are subranges therein. Ranges R6-R9 can be substantially free of lithium and/or free of lithium, and Ranges R8-R9 are both substantially free of lithium and free of lithium. Compared to Ranges R6-R8, Range R9 provides narrower ranges for the first component and the second component. Compared to Ranges R7-R9, Ranges R10-R11 comprise more lithium. Ranges R9 and R11 comprise the narrowest ranges in Table 2.

TABLE 2
Composition (atom %) of the Alloy of the Anode (as-formed)

| Range | R6 | R7 | R8 | R9 | R10 | R11 |
|---|---|---|---|---|---|---|
| Lithium | 0-50 | 0-5 | 0 | 0 | 10-50 | 10-50 |
| First Component | 20-99 | 80-99 | 80-99 | 88-95 | 30-70 | 38-45 |
| Second Component | 1-20 | 1-20 | 1-20 | 5-12 | 1-20 | 5-12 |

FIG. 2 illustrates a solid-state battery with the anode 112 comprising the alloy. As shown in FIG. 2, the solid-state battery 201 can comprise a coin-cell form, although the battery can comprise another form in other aspects. Compared to FIG. 1, FIG. 2 is a simplified solid-state battery 201 because the optional first coating 106 and the optional second interlayer or second coating 110 is omitted. Consequently, the first major surface 113 of the anode 112 can be in direct contact with the first major surface 109 of the solid-state electrolyte 108, for example, because the optional second interlayer or second coating 110 is omitted. Also, the interlayer 114 can be in direct contact with the cathode 104 and the solid-state electrolyte 108, for example, because the optional first coating 106 is omitted. In aspects, as shown in FIG. 2, the area of the first major surface 113 of the anode 112 can be less than or equal to (e.g., less than) the area of the first major surface 109 of the solid-state electrolyte 108. In further aspects, as shown, the area of the first major surface 113 of the anode 112 can be substantially equal to a corresponding area of the cathode 104. Alternatively, as shown in FIG. 1, the area of the first major surface 113 of the anode 112 can be substantially equal to the area of the first major surface 109 of the solid-state electrolyte 108. In aspects, as shown in FIG. 2, an electrically insulating layer 205a and 205b can be positioned between the first current collector 102 and the second current collector 116 to prevent a short circuit in the solid-state battery 201 and/or to form a barrier protecting the contents of the solid-state battery 201. As used herein, the electrically insulating layer 205a and 205b comprises an electronic conductivity of 10⁻⁵ S/cm or less. In even further aspects, as shown, the electrically insulating layer 205a and 205b can be configured to maintain a configuration of the solid-state battery 201, for example, by preventing the solid-state electrolyte 108 from contacting the second current collector 116. In further aspects, the electrically insulating layer 205a and 205b can comprise a polymeric material, for example, a fluoropolymer, a rubber, a polyurethane, or a silicone. In aspects, as shown, the solid-state battery 201 can further comprise an electrically conductive spacer 203 positioned between the anode 112 and the second current collector 116. In further aspects, the electrically conductive spacer 203 can comprise a foam (e.g., Ni foam), which can help maintain contact between adjacent components of the solid-state battery and/or control an amount of stress that the components of the solid-state battery are subjected to. Although not shown, an electrically conductive spacer can be positioned between the cathode and the first current collector.

Unless otherwise specified, a cycle comprises a charging current density of 2 mA/cm² to a predetermined nominal capacity and a discharge current density of 0.75 mAh/cm² while the battery is maintained at 60° C. As used herein, “nominal capacity” refers to a capacity achieved using a predetermined charging condition in a first charging step for the battery. As used herein, a “fully charged state” of a battery refers to battery that has been charged to a nominal capacity of 2 mAh/cm² or more. In aspects, after at least one cycle, the anode comprises the alloy with composition within one or more of the ranges discussed above with reference to Table 1 and the paragraph preceding discussion of Table 1.

Throughout the disclosure, capacity retention refers to the percent of an original capacity that the solid-state battery can achieve after a predetermined cycle using the same charge-discharge cycle for all cycles. In aspects, after 50 cycles or more to a nominal capacity of 2.1 mAh/cm² (with a charging current density of 2 mA/cm² and a discharge current density of 0.75 mAh/cm² while the battery is maintained at 60° C.), the solid-state battery can exhibit a capacity retention of about 90% or more, about 93% or more, or about 95% or more, for example, from about 90% to 100%, from about 93% to 100%, from about 95% to 100%, or any range or subrange therebetween. In aspects, after 50 cycles or more to a nominal capacity of 3.3 mAh/cm² (with a charging current density of 2 mA/cm² and a discharge current density of 0.75 mAh/cm² while the battery is maintained at 60° C.), the solid-state battery can exhibit a capacity retention of about 90% or more, about 93% or more, or about 95% or more, for example, from about 90% to 100%, from about 93% to 100%, from about 95% to 100%, or any range or subrange therebetween. In aspects, after 50 cycles or more to a nominal capacity of 3.5 mAh/cm² (with a charging current density of 2 mA/cm² and a discharge current density of 0.75 mAh/cm² while the battery is maintained at 60° C.), the solid-state battery can exhibit a capacity retention of about 90% or more, about 93% or more, or about 95% or more, for example, from about 90% to 100%, from about 93% to 100%, from about 95% to 100%, or any range or subrange therebetween. In aspects, after 20 cycles or more to a nominal capacity of 5 mAh/cm² (with a charging current density of 2 mA/cm² and a discharge current density of 0.75 mAh/cm² while the battery is maintained at 60° C.), the solid-state battery can exhibit a capacity retention of about 90% or more, about 93% or more, or about 95% or more, for example, from about 90% to 100%, from about 93% to 100%, from about 95% to 100%, or any range or subrange therebetween. Maintaining a high capacity retention (e.g., 95% or more after 50 cycles or more to a nominal capacity of 2.1 mAh/cm², 93% or more after 50 cycles or more to a nominal capacity of 3.3 mAh/cm², 95% or more after 50 cycles or more to a nominal capacity of 3.5 mAh/cm², 95% or more after 20 cycles to a nominal capacity of 5 mAh/cm²) can enable the solid-state battery to be functional for an intended use for a longer period of time than would otherwise be possible.

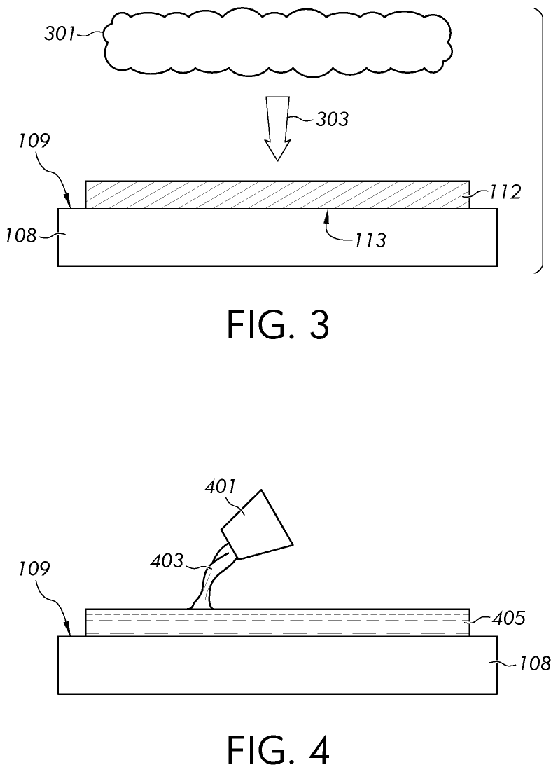

Aspects of methods of making the solid-state battery in accordance with aspects of the disclosure will be discussed with reference to example method steps illustrated in FIGS. 3-6. As shown in FIGS. 3-4, methods can comprise disposing an alloy (e.g., molten alloy 405, anode 112) on a solid-state electrolyte 108 (e.g., first major surface 109) as part of forming the anode 112. In aspects, as shown in FIG. 3, disposing an alloy (e.g., anode 112) can comprise deposition (as indicated by arrow 303) from a gas phase (as indicated by cloud 301). In further aspects, the alloy (e.g., anode 112) can be formed by sputtering from one or more sources (e.g., elemental targets or an alloy target). In further aspects, the alloy (e.g., anode 112) can be formed by thermal evaporation. In further aspects, other methods of physical vapor deposition (PVD) can be used to form the alloy (e.g., anode 112).

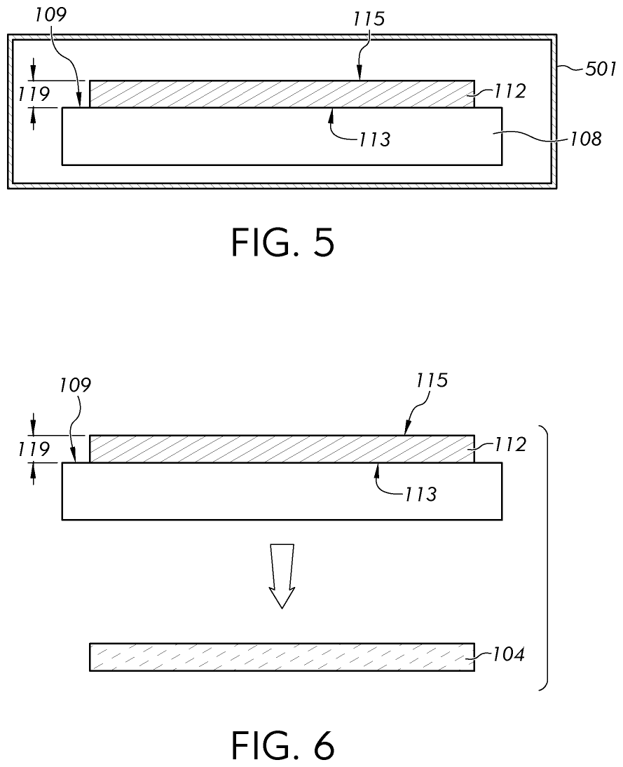

Alternatively, as shown in FIG. 4, methods can comprise disposing a molten alloy 405 on the first major surface 109 of the solid-state electrolyte 108. As shown, disposing the molten alloy 405 can comprise dispensing one or more molten metals 403 (e.g., elemental metal or alloy) (i.e., molten state) from a source 401 (e.g., metal foil, conduit, micropipette, or syringe). Alternatively, the alloy can be disposed on the solid-state electrolyte by attaching a metal foil comprising the alloy to the first major surface of the solid-state electrolyte, which can be treated as discussed below with reference to FIG. 5.

In aspects, after or during disposing the alloy (e.g., molten alloy 405, anode 112), as shown in FIG. 5, the solid-state electrolyte 108 and the alloy can be in an environment maintained at a first temperature. For example, as shown, the solid-state electrolyte 108 can be placed in an oven 501 maintained at the first temperature. The first temperature is greater than a melting point of the one or more materials used to form the alloy (including the alloy itself). In further aspects, the first temperature can be greater than a melting point of the one or more materials used to form the alloy by about 50° C. or more, about 100° C. or more, about 125° C. or more, or about 150° C. or more. For example, lithium metal has a melting temperature of about 180° C. In aspects, the first temperature can be about 280° C. or more, about 300° C. or more, about 320° C. or more, about 500° C. or less, about 400° C. or less, or about 350° C. or less, for example, from about 280° C. to about 500° C., from about 300° C. to about 400° C., from about 320° C. to about 350° C., or any range or subrange therebetween. In further aspects, after disposing the alloy, the solid-state electrolyte 108 and the alloy can be maintained at the first temperature for about 1 minute or more, about 3 minutes or more, about 5 minutes or more, about 15 minutes or more, about 20 minutes or more, about 1 hour or less, about 45 minutes or less, about 30 minutes or less, or about 25 minutes or less. In further aspects, after disposing the alloy, the solid-state electrolyte 108 and the alloy can be maintained at the first temperature for a time ranging from about 1 minute to about 1 hour, from about 3 minutes to about 45 minutes, from about 5 minutes to about 30 minutes, from about 15 minutes to about 30 minutes, from about 20 minutes to about 25 minutes, or any range or subrange therebetween. Providing a temperature and time within one or more of the above-mentioned ranges can enable the formation of a substantially homogeneous alloy and/or anneal the alloy to conform to the first major surface 109 of the solid-state electrolyte 108.

After depositing the alloy and/or holding the alloy in an environment maintained at the first temperature, the alloy can form the anode 112 (i.e., “as formed”) comprising the anode thickness 119 within one or more of the ranges discussed above for the anode thickness 119. Also, the anode 112 can comprise the alloy comprising a composition within one or more of the ranges discussed above for the alloy (including the ranges in Tables 1-2).

After forming the anode 112, as shown in FIG. 6, methods can comprise disposing the solid-state electrolyte 108 on the cathode 104, as indicated by the arrow. As shown, the cathode 104 can be opposite the first major surface 109 of the solid-state electrolyte 108 and the anode 112. As shown, the solid-state electrolyte 108 is positioned between the cathode 104 and the anode 112. Although not shown, the interlayer 114 and/or additional elements (e.g., current collectors) can be present when the solid-state electrolyte is disposed on the cathode and/or additional elements can be added after disposing the cathode to form the battery (e.g., solid-state battery 101 or 201).

In aspects, after disposing the solid-state electrolyte 108 on the cathode 104 (e.g., forming the battery), the composition of the anode 112 (from as-formed to in a fully charged state) can change after cycling the battery at least one time. For example, the composition of the alloy of the anode as-formed can be within one or more of the Ranges in Table 2 (or the preceding paragraphs), and the composition of the alloy of the anode when the battery is in a fully charged state can be within one or more of the Ranges in Table 1 (or the preceding paragraphs).

### EXAMPLES

Various aspects will be further clarified by the following examples. Examples (Ex) 1-5 and Comparative Examples (CE) 1-4 comprise NCM523 cathode with a diameter of 12 mm, a lithium garnet (discussed below) solid-state electrolyte with a diameter of 14 mm and a thickness of 0.6 mm, the anode comprised lithium metal foil comprising a diameter of 12 mm and a thickness of 0.3 mm. NCM523 refers to LiN_{0.5}Co_{0.2}Mn_{0.3}O₂ (precursor commercially available from Landt Instruments), which was formed into slurry with a 8:1:1 weight ratio of the precursor, super P carbon black (available from Timcal—Imerys), and poly(vinylidene fluoride) (PVDF) (dissolved in N-methylpyrrolidone) that was coated on aluminum (Al) foil with a predetermined thickness and dried under vacuum. Examples 1-5 and Comparative Examples 1-4 were processed in accordance with the methods discussed above, for example, with heating the disposed anode-precursor (e.g., alloy) at 340° C. for 30 minutes to form the anode on the lithium garnet solid-state electrolyte (discussed below) and the NCM523 cathode to form a battery resembling the solid-state battery 201 shown in FIG. 2 in a CR2025 coin cell form with Ni foam disposed on the anode.

The lithium garnet solid-state electrolyte was cubic phase Li_{6.5}La₃Zr_{1.4}Ta_{0.5}O₁₂ (LLZTO), which was synthesized from a stoichiometric ratio of starting powders of LiOH·H₂O (AR), La₂O₃ (99.99%), ZrO₂ (AR), Ta₂O₅ (99.99%). 2 wt % excess of LiOH·H₂O added to compensate the lithium loss during processing. La₂O₃ was heated at 900° C. for 12 hours to remove any moisture and/or CO₂. The raw materials were mixed via a wet grinding process in which yttrium stabilized zirconium oxide (YSZ) balls and isopropanol (IPA) were used as the milling media. The mixture was dried and calcined at 950° C. for 6 hours in an alumina crucible to obtain pure cubic garnet phase powder. These powders were pressed into green pellets and sintered at 1230° C. for 1 hour, covered with LLZTO powder with 15 wt % Li excess in platinum crucibles.

Before assembly, the lithium garnet solid-state electrolyte sheets were dry polished followed by immersing in 1 mol/L HCl solution (in ethanol) for 10 minutes. After that, in an argon-filled glovebox, the anode-precursor (e.g., alloy) was disposed on the lithium garnet solid-state electrolyte and was heated at 340° C. for 30 minutes followed by naturally cooling to room temperature (e.g., 25° C.) to form the anode on the lithium garnet solid-state electrolyte. An interlayer was formed comprising 3 molar lithium bis(fluorosulfonyl)imide (LIFSI) in sulfolane with a volume of 10 μL per square centimeter (μL/cm²) of a major surface of the cathode was disposed on the cathode before the lithium garnet solid-state electrolyte was disposed thereon. An Ni foam with the same diameter as the anode was placed on the top of anode, and the battery was sealed in a CR2025 coin cell with an applied pressure of 5 MPa.

As shown in Table 1, Examples 1-5 comprised ternary alloys. Examples 1-3 comprise a ternary alloy of lithium, magnesium, and calcium; Example 4 comprises a ternary alloy of lithium, magnesium, and tin; and Example 5 comprises a ternary alloy of lithium, magnesium, and silver. Comparative Example 1-2 comprise a lithium metal anode, Comparative Examples 3-4 comprise a binary alloy of lithium and magnesium, and Comparative Example 5 comprises a binary alloy of lithium and calcium.

TABLE 3
Properties of Examples 1-5 and Comparative Examples 1-4

| | | First | Second | Nominal | |
|---|---|---|---|---|---|
| | Anode | Component | Component | Capacity | |
| Example | Composition | (wt %) | (wt %) | (mAh/cm²) | Failure |
| Ex. 1 | Li_{0.89}Mg_{0.10}Ca_{0.01} | 26.9 | 3.8 | 2.1 | No |
| Ex. 2 | Li_{0.89}Mg_{0.10}Ca_{0.04} | 23.3 | 16.7 | 2.1 | 20 cycles |
| Ex. 3 | Li_{0.89}Mg_{0.10}Ca_{0.01} | 26.9 | 3.8 | 3.3 | No |
| Ex. 4 | Li_{0.89}Mg_{0.10}Sn_{0.01} | 24.6 | 12.3 | 3.5 | No |
| Ex. 5 | Li_{0.89}Mg_{0.10}Ag_{0.01} | 24.8 | 11.5 | 5 | No |
| CE 1 | Li metal (100%) | n/a | n/a | 1.1 | 45 cycles |
| | | | | | (capacity reduction) |
| CE 2 | Li metal (100%) | n/a | n/a | 3.3 | <10 cycles |
| CE 3 | Li_{0.90}Mg_{0.10} | 28 | n/a | 1.1 | No |
| CE 4 | Li_{0.90}Mg_{0.10} | 28 | n/a | 3.3 | No |
| CE 5 | Li_{0.90}Ca_{0.10} | 46 | n/a | 1.1 | No |

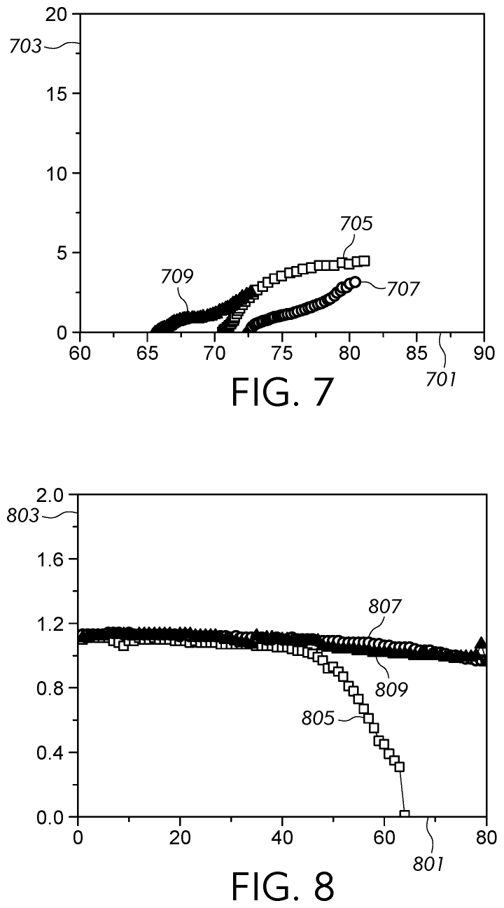

FIG. 7 illustrates a Nyquist plot measured at 60° C., where the horizontal axis 701 corresponds to the real component of impedance (Z′ measured in Q cm²) and the vertical axis 703 corresponds to the negative imaginary component of impedance (Z″ measured in Ω cm²) for frequencies from 0.1 Hertz (Hz) to 1 MegaHertz (MHz) using Solartron 1260A impedance analyzer. Curves 705, 707, and 709 correspond to the performance of the as-formed solid-state battery of Comparative Examples 1, 3, and 5, respectively. Throughout the disclosure, “interfacial resistance” is defined as the difference between the real components of the impedance for the end-points of the arc shape in impedance results (i.e., Nyquist plot), where the higher end-point is taken as an inflection point in the impedance results. Curves 705, 707, and 709 comprise an interfacial resistance of about 1 Ωcm² or less, demonstrating that the heat treatment in forming the anode on the solid-state electrolyte produces good contact therebetween.

Examples 1-5 and Comparative Examples 1-5 were tested by cycling to the nominal capacity stated in Table with a charging current density of 2 mA/cm² and a discharge current density of 0.75 mAh/cm² at 60° C. using a CT2001A Battery Test System (Landt). FIG. 8 presents the capacity retention of Comparative Examples 1, 3, and 5 for up to 80 cycles represented by curves 805, 807, and 809, respectively. In FIG. 8, the horizontal axis 801 is the number of cycles, and the vertical axis 803 is capacity (mAh/cm²). Curve 805 shows that the battery of Comparative Example 1 failed at about 63 cycles to a nominal capacity of 1.1 mAh/cm². Curves 807 and 809 demonstrate that Comparative Examples 3 and 5 can retain about 90% or more of the nominal capacity of 1.1 mAh/cm² for 80 cycles. The binary alloy of Comparative Examples 3 and 5 can provide better capacity retention and increased longevity of the battery for low nominal capacity (1.1 mAh/cm²).

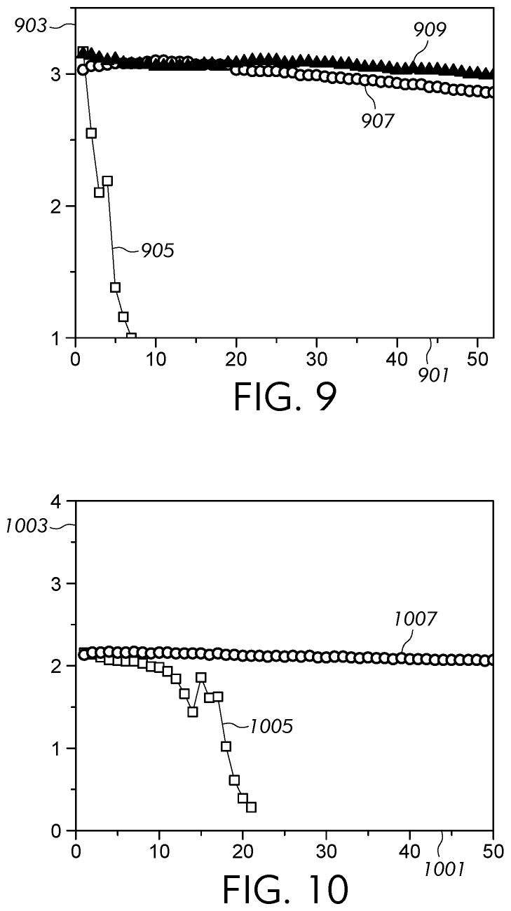

FIG. 9 presents the capacity retention of Comparative Example 2, Comparative Example 4, and Example 3 for up to 50 cycles to a nominal capacity of 3.3 mAh/cm² represented by curves 905, 907, and 909, respectively. In FIG. 9, the horizontal axis 901 is the number of cycles, and the vertical axis 903 is capacity retention in mAh/cm². For curve 905 (Comparative Example 2), the battery with a lithium metal anode failed in less than 10 cycles. In contrast, Comparative Example 4 and Example 3 withstand 50 cycles with a capacity retention of about 90% or more. This demonstrates that lithium alloy anodes batteries to function at higher capacities (e.g., 3.3 mAh/cm²) than lithium metal anodes. As discussed above, it is believed that the alloy can enable the anode to remain in contact with the solid-state electrolyte even when the battery is in a discharged state and/or the battery is subjected to charging/discharging-induced stresses, for example, because the non-lithium component(s) of the alloy may not be transferred during cycling (e.g., charging, discharging). Further, Example 3 demonstrates a capacity retention of 95% or more, which is better than Comparative Example 4.

FIG. 10 presents the capacity retention of Example 2 and Example 1 for 50 cycles to a nominal capacity of 2.2 mAh/cm² represented by curves 1005 and 1007, respectively. In FIG. 10, the horizontal axis 1001 is the number of cycles, and the vertical axis 1003 is capacity retention in mAh/cm². As shown, curve 1005 demonstrates that Example 2 fails after about 20 cycles. In contrast, as demonstrated by curve 1007, Example 1 withstands 50 cycles with about 95% or more capacity retention. As discussed below with reference to FIGS. 15-17, large granules of CaLi₂ appear on the surface of alloy anodes with about 4 atom % calcium or more, which can disrupt an otherwise smooth surface of the anode that may lead to decreased performance of a battery containing such alloy anodes. It is to be understood that the threshold for such a decrease in performance may be at different (e.g., higher) atom % of second components other than calcium.

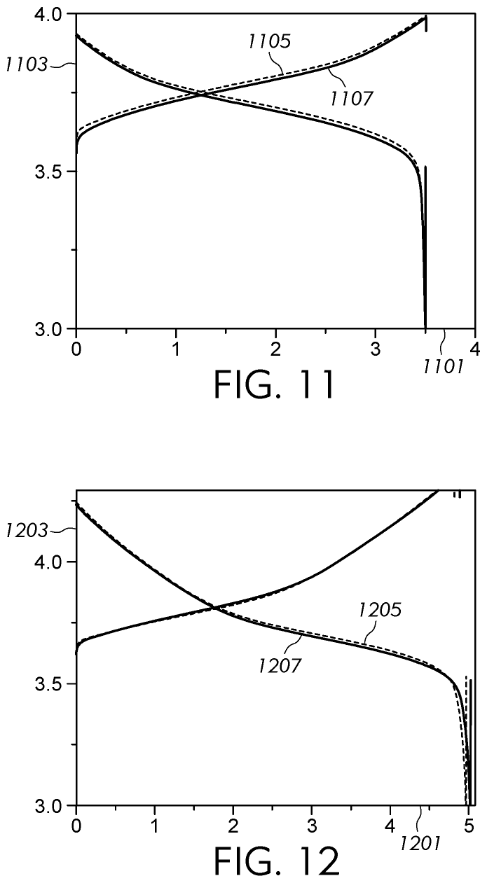

FIGS. 11 and 12 illustrate capacity-voltage (CV) curves for Example 4 and Example 5, respectively. The horizontal axis 1101 or 1201 is capacity in mAh/cm², and the vertical axis 1103 or 1203 is voltage in Volts (V). In FIG. 11, curve 1105 corresponds to a trace for the second (2nd) cycle of Example 4, and curve 1107 corresponds to the trace for the fiftieth (50th) cycle of Example 4. As shown, curves 1105 and 1107 comprise the same shape with curve 1107 being less than curve 1105 by 0.1 V or less (e.g., 0.05 V or less, about 0.02 V or less). This demonstrates that the battery of Example 4 provides substantially uniform performance over multiple charging cycles (e.g., to a nominal capacity of 3.5 mAh/cm²). Also, Example 4 exhibited capacity retention of 95% or more for 50 cycles to a nominal capacity of 3.5 mAh/cm².

In FIG. 12, curve 1205 corresponds to a trace for the second (2nd) cycle of Example 5, and curve 1207 corresponds to the trace for the twentieth (20th) cycles of Example 5. The discharging portion of curves 1205 and 1207 substantially overlap, and there is only slight differences for a final part of the charging portion of curves 1205 and 1207. Example 5 exhibited capacity retention of 95% or more for 20 cycles to a nominal capacity of 5 mAh/cm². FIGS. 11 and 12 demonstrate that anodes comprising ternary alloys (e.g., Examples 4-5) in accordance with aspects of the disclosure can increase capacity retention at high capacity (e.g., about 2 mAh/cm² or more, about 3 mAh/cm²) relative to anodes comprising binary alloys (Comparative Examples 3-5) and additionally longevity relative to lithium metal anodes (Comparative Examples 1-2).

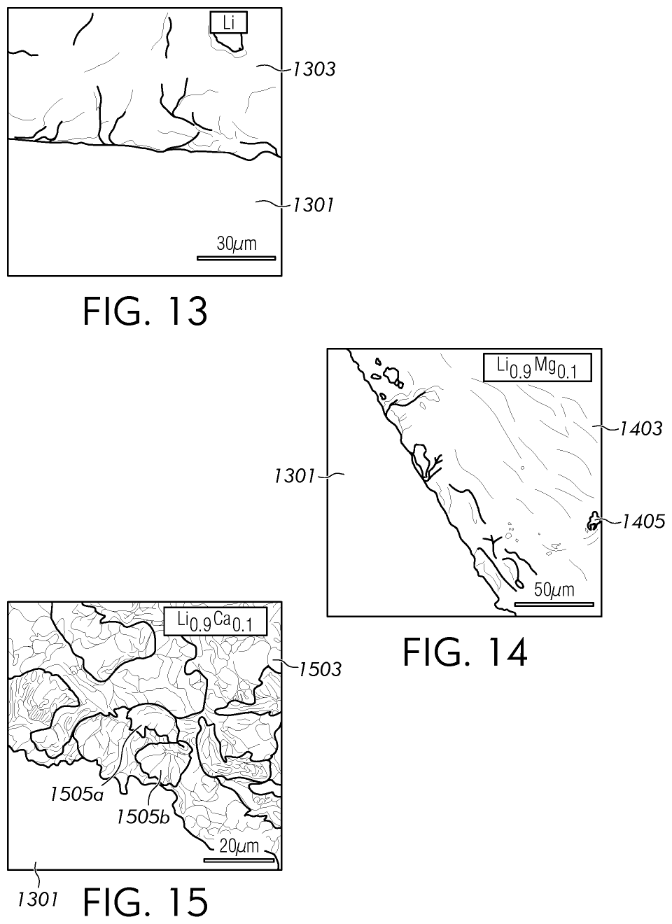

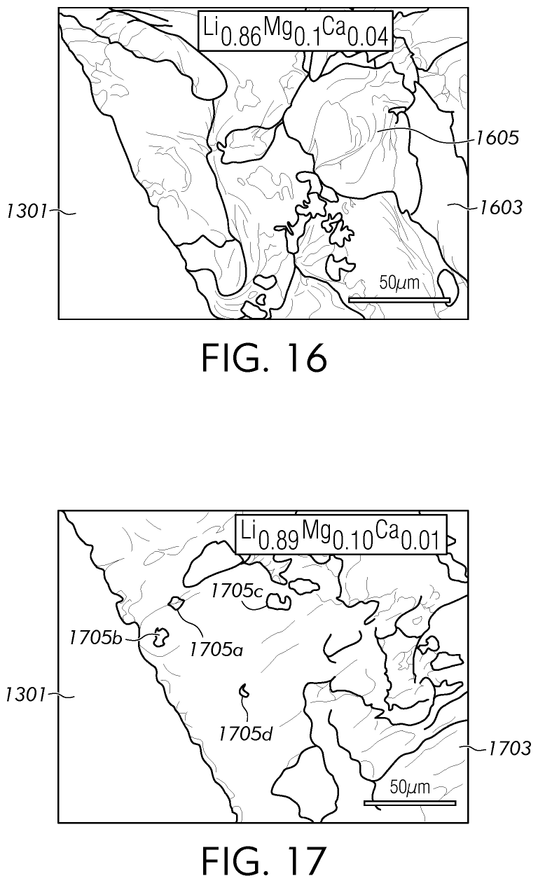

FIGS. 13-19 schematically represent images taken using a scanning electron microscope (SEM) of anodes as-formed. FIGS. 13-15 correspond to Comparative Examples 1, 3, and 5, respectively. FIGS. 16-19 correspond to Examples 2, 1, 4, and 5, respectively. In FIGS. 13-19, portion 1301 is the lithium garnet solid electrolyte. As shown in FIG. 13, the lithium metal anode 1303 of Comparative Example 1 provides a substantially flat surface. Likewise, the lithium-magnesium binary alloy anode 1403 of Comparative Example 3 of FIG. 14 has a substantially flat and homogenous surface, although there are some impurities 1405 are observed. Without wishing to be bound by theory, it is believed that magnesium (and silver) can form solid solutions with lithium, as reflected by the substantially flat and homogenous surface shown in FIG. 14.

In FIG. 15, the lithium-calcium surface 1503 of Comparative Example 5 (with 10 atom % Ca) is uneven with large granules 1505a and 1505b (e.g., having a diameter greater than 10 μm) of CaLi₂. Likewise, in FIG. 16, the lithium-magnesium-calcium alloy anode 1603 of Example 2 comprising 4 atom % Ca has a large granule 1605 and several smaller granules of CaLi₂. Since calcium does not form a solid solution with lithium, large amounts of calcium (e.g., 4 atom % or more, 10 atom % or more) can aggregate as granules of CaLi₂ that produces an uneven surface and may concentrate lithium. As demonstrated in FIG. 10, Example 2 with the large CaLi₂ granules can have performance issues at higher capacity (e.g., 3.3 mAh/cm²). Without wishing to be bound by theory, higher capacity cycling (e.g., 3 mAh/cm² or more) can deplete a large fraction of the lithium in the anode to such an extent that the lithium held in large granules (that can be away from the anode/electrolyte interface) can be problematic. Additionally or alternatively, the large CaLi₂ granules can facilitate the formation of voids at the anode/electrolyte interface in response to cycling-induced stresses, and such stresses are higher at higher capacity cycling.

In FIG. 17, the lithium-calcium-magnesium anode 1703 of Example 1 (with 1 atom % Ca) has smaller CaLi₂ granules 1705a-1705d than those seen in FIGS. 15-16. Based on the performance issues of Comparative Example 5 (with 10 atom % Ca) at a nominal capacity of 3.3 mAh/cm² and the presence of CaLi₂ granules (in both Comparative Example 5 and Examples 1-2 in FIGS. 15-17), it is unexpected that Example 1 (with 1 atom % Ca) can improve the performance of a battery (e.g., increased capacity retention, increased longevity).

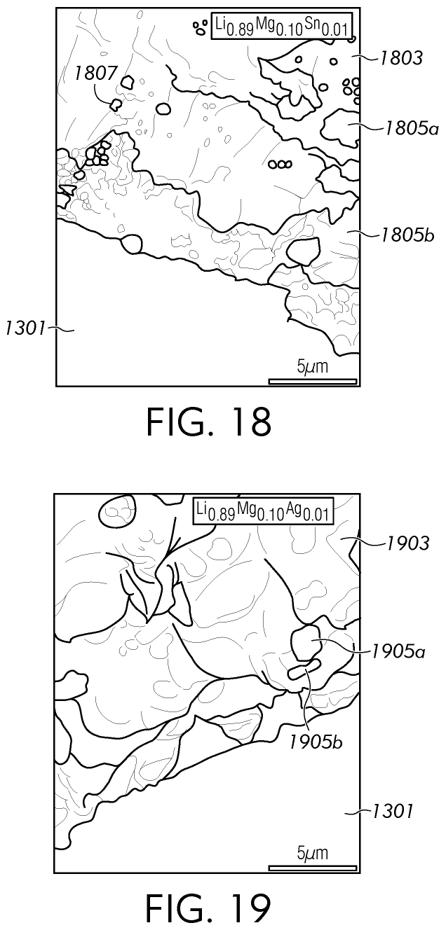

In FIG. 18, the lithium-calcium-tin anode 1803 of Example 4 has tin-containing granules 1805a-1805b (note the 10× magnification relative to FIGS. 16-17) and smaller granules 1807. Likewise, FIG. 19 shows smaller granules 1905a-1905b of lithium-calcium-silver anode 1903 of Example 5 than those in FIGS. 16-17 and 18. It is expected that Examples 4-5 will have performance comparable to or better than Example 1.

The above observations can be combined to provide batteries and methods of making the same comprising an alloy anode. The alloy anode comprises at least a first component and a second component. The first component can for a solid solution with a metal and/or metal ion (e.g., Li/Li+) that is transported during cycling of the battery. The second component may not form a solid solution with the first component, metal and/or the material (e.g., Li/Li+) transported during cycling of the battery. Providing the first component and the second component (with an amount of the first component greater than an amount of the second component) can enable the anode to remain in contact with the solid-state electrolyte even when the battery is in a discharged state and/or the battery is subjected to charging/discharging-induced stresses, for example, because the first component and the second component may not be transferred during cycling (e.g., charging, discharging). Maintaining contact between the anode and the solid-state electrolyte during cycling can minimize interfacial resistance therebetween, which can increase a capacity retention and longevity of the battery. As demonstrated in the Examples, including the second component can unexpectedly improve performance (e.g., capacity retention, longevity) of batteries compared to lithium metal anodes and binary alloy anodes as well as when analyzing the microstructure of such anodes (see SEM images). Maintaining a high capacity retention (e.g., 95% or more after 50 cycles or more to a nominal capacity of 2.1 mAh/cm², 93% or more after 50 cycles or more to a nominal capacity of 3.3 mAh/cm², 95% or more after 50 cycles or more to a nominal capacity of 3.5 mAh/cm², 95% or more after 20 cycles to a nominal capacity of 5 mAh/cm²) can enable the solid-state battery to be functional for an intended use for a longer period of time than would otherwise be possible.

Providing a majority of the atoms in the alloy (e.g., in a battery in a fully charged state) as lithium allows for the anode to be used in high area capacity (e.g., 2.1 mAh/cm² or more, 3.3 mAh/cm² or more, 5 mAh/cm² or more). In aspects, providing an as-formed anode with reduced lithium, substantially free of lithium, and/or free of lithium can simplify processing and/or reduce manufacturing costs while still achieving a functional battery, where an amount of lithium in the anode increases during charging as lithium in other components (e.g., cathode, solid-state electrolyte) is transported to the anode.

Providing a solid-state electrolyte (e.g., in a solid-state battery) can address common safety concerns, for example, leakage, poor chemical stability, and flammability often seen in batteries employing liquid electrolytes. Moreover, providing a solid-state electrolyte can also suppress polysulfide shuttling from the cathode to the anode, thereby leading to improved electrode (e.g., anode, cathode) utilization and a high discharge capacity and energy density. Providing a solid-state electrolyte can reduce a formation of dendrites (e.g., lithium dendrites) that can otherwise result in failure of the battery. Providing an interlayer 114 comprising a liquid electrolyte can wet the interface between the cathode 104 and the solid-state electrolyte to reduce interfacial resistance therebetween while minimizing a total amount of liquid electrolyte in the solid-state battery 101.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed is:

1. A battery comprising:
a cathode;
a solid-state electrolyte; and
an anode comprising an alloy comprising, as an atom % of the alloy as-formed or in a fully charged state:
from about 50 atom % to about 90 atom % of lithium;
from about 5 atom % to about 50 atom % of a first component selected from a group consisting of magnesium, silver, and combinations thereof, and
from about 0.1 atom % to about 10 atom % of a second component selected from a group consisting of calcium, aluminum, gallium, boron, carbon, silicon, tin, zinc, indium, antimony, silver, and combinations thereof,
wherein the solid-state electrolyte is positioned between the cathode and the anode, and an amount of the first component is greater than an amount of the second component.

2. The battery of claim 1, wherein a thickness of the anode is from 1 micrometer to about 500 micrometers.

3. The battery of claim 1, wherein the first component is from about 8 atom % to about 15 atom %.

4. The battery of claim 1, wherein the second component is from about 0.1 atom % to about 3 atom %.

5. The battery of claim 1, wherein the solid-state electrolyte comprises a lithium-phosphorous-oxynitride (LiPON), lithium garnet (Li₇La₃Zr₂O₁₂), lithium phosphosulfide, or combinations thereof.

6. The battery of claim 1, wherein a capacity of the battery after 50 cycles is from about 95% to 100% of an initial capacity, each cycle comprises a charging current density of 2 mA/cm² to a nominal capacity of 2.1 mAh/cm² and a discharge current density of 0.75 mAh/cm² while the battery is maintained at 60° C.

7. The battery of claim 1, wherein a capacity of the battery after 50 cycles is from about 93% to 100% of an initial capacity, each cycle comprises a charging current density of 2 mA/cm² to a nominal capacity of 3.3 mAh/cm² and a discharge current density of 0.75 mAh/cm² while the battery is maintained at 60° C.

8. A battery comprising:
a cathode;
a solid-state electrolyte; and
an anode comprising an alloy comprising, as an atom % of the alloy as-formed:
from about 20 atom % to about 99 atom % of a first component selected from a group consisting of magnesium, silver, and combinations thereof, and
from about 1 atom % to about 20 atom % of a second component selected from a group consisting of calcium, aluminum, gallium, boron, carbon, silicon, tin, zinc, indium, antimony, and combinations thereof,
wherein the solid-state electrolyte is positioned between the cathode and the anode, and an amount of the first component is greater than an amount of the second component.

9. The battery of claim 8, wherein one or both of the cathode or the solid-state electrolyte comprises lithium, and the anode as-formed consists of from about 80 atom % to about 99 atom % of the first component and from about 1 atom % to about 20 atom % of the second component.

10. The battery of claim 8, wherein a thickness of the anode is from 1 micrometer to about 500 micrometers.

11. The battery of claim 8, wherein the solid-state electrolyte comprises a lithium-phosphorous-oxynitride (LiPON), lithium garnet (Li₇La₃Zr₂O₁₂), lithium phosphosulfide, or combinations thereof.

12. The battery of claim 8, wherein a capacity of the battery after 50 cycles is from about 95% to 100% of an initial capacity, each cycle comprises a charging current density of 2 mA/cm² to a nominal capacity of 2.1 mAh/cm² and a discharge current density of 0.75 mAh/cm² while the battery is maintained at 60° C.

13. The battery of claim 8, wherein a capacity of the battery after 50 cycles is from about 93% to 100% of an initial capacity, each cycle comprises a charging current density of 2 mA/cm² to a nominal capacity of 3.3 mAh/cm² and a discharge current density of 0.75 mAh/cm² while the battery is maintained at 60° C.

14. The battery of claim 8, wherein after at least one cycle, the anode comprises, as an atom % of the alloy in a fully charged state:
from about 50 atom % to about 90 atom % of lithium;
from about 5 atom % to about 50 atom % of the first component; and
from about 0.1 atom % to about 10 atom % of the second component.

15. A method of making the battery of claim 1, comprising:
disposing the anode on the solid-state electrolyte by disposing the alloy on the solid-state electrolyte; and
disposing the solid-state electrolyte on the cathode, wherein the solid-state electrolyte is positioned between the cathode and the anode.

16. The method of claim 15, wherein the disposing the alloy comprises depositing one or more materials in a molten state on the solid-state electrolyte in an environment maintained at a temperature greater than a melting point of the one or more materials by about 100° C. or more for from about 5 minutes to about 30 minutes.

17. The method of claim 15, wherein disposing the alloy comprising sputtering or thermal evaporation to dispose the anode.

18. A method of making the battery of claim 8, comprising:
disposing the anode on the solid-state electrolyte by disposing the alloy on the solid-state electrolyte; and
disposing the solid-state electrolyte on the cathode, wherein the solid-state electrolyte is positioned between the cathode and the anode.

19. The method of claim 18, wherein disposing the alloy comprising sputtering or thermal evaporation to dispose the anode.

20. The method of claim 18, further comprising, after disposing the anode, cycling the battery at least one time, wherein after the cycling the battery at least one time, the anode, as an atom % of the alloy in a fully charged state, comprises:
from about 50 atom % to about 90 atom % of lithium;
from about 5 atom % to about 50 atom % of the first component; and
from about 0.1 atom % to about 10 atom % of the second component.
